(19) United States
(12) Patent Application Publication
(10) Pub. No.: US 2002/0059563 A1
(43) Pub. Date: May 16, 2002

(54) Method and system for self-adaptive code

(76) Inventors: Dusko Pavlovic, Palo Alto, CA (US); Douglas R. Smith, Mountain View, CA (US); Stephen Fitzpatrick, Pacifica, CA (US)

Correspondence Address: FENWICK & WEST LLP, TWO PALO ALTO SQUARE, PALO ALTO, CA, 94306, US

(21) Appl. No.: 09/836,582

(22) Filed: Apr. 16, 2001

Related U.S. Application Data
(60) Provisional application No. 60/197,909, filed on Apr. 16, 2000.
(60) Provisional application No. 60/197,983, filed on Apr. 17, 2000.

(51) Int. Cl. G06F 9/44

(52) U.S. Cl. 717/137

(57) ABSTRACT

A computer-implemented method and system for allowing software to carry its own specification.

### RELATED APPLICATIONS

This application claims priority under 35 U.S.C. §119(e) to U.S. application Ser. No. 60/197,909 entitled “Method and Apparatus for Self-Adaptive Code” of Pavlovic et al., filed Apr. 16, 2000, and to U.S. application Ser. No. 60/197,983 entitled “Method and Apparatus for Self-Adaptive Code” of Pavlovic et al., filed Apr. 17, 2000, both of which are herein incorporated by reference in their entirety.

This application is related to U.S. application Ser. No. 09/665,179 of Pavlovic and Smith, filed Sep. 19, 2000, which is herein incorporated by reference in its entirety.

### BACKGROUND OF THE INVENTION

The present invention relates generally to system design and, specifically, to a method and system that allow software code to carry its own specification.

The design of systems, such as computer systems or engineering systems is a complex process. While it is possible to design systems from scratch using a minimum of design tools, most modem designers use tools to represent and manipulate designs for complex systems.

In the past, most structural problems with software were attributed to lazy programmers, who wrote spaghetti code and not enough comments. Structuring and literate programming were proposed as solutions.

What is needed is way to help automate the process of fitting software modules together and of automating the process of determining whether software modules are composable with each other.

### SUMMARY OF THE INVENTION

The present invention allows the design and utilization of “specification-carrying software.” In the described embodiment, software is extended with comments in a generic specification language, or with Floyd-Hoare annotations, although other types of specifications can be used. Specifications preferably are extended with executable (partial) implementations, or abstract, but verifiable behaviors.

A specification is not merely a static formalization of requirements. (Such requirements are usually not completely determined). Instead, a specification is the currently known structural and/or behavioral properties, functional or otherwise of the software. It is automatically updated, following evolution of the runnable component itself.

Use of a specification makes the idea of embedding a model in software precise: a model is a spec. The idea of a model is that it is an abstraction of reality, displaying what we care for, and abstracting away the rest. That is what software specifications do in a formal and systematic way.

In a way, the carried specifications are like genes: each component carries the blueprint of itself. It precludes combining incompatible components, as alien species. It can be used for certifying, similarly like protein markers which cells use to distinguish friends from enemies.

Accommodate the dynamics of ever changing interfaces, and the unpredictable interactions arising from the ever-changing environments. The fact that the architectures never stop changing should not be taken as a nuisance, but recognized as the essence of the game of software, built into its foundation, and implemented as a design routine.

### BRIEF DESCRIPTION OF THE DRAWINGS

FIG. 1 is a block diagram of the overall architecture of an embodiment of the present invention.

FIGS. 2(a) and 2(b) are flow charts showing step-wise refinements of a specification.

FIGS. 3(a) and 3(b) show a conceptual example of a colimit operation.

FIGS. 4(a) and 4(b) show another conceptual example of a colimit operation.

FIG. 5 shows an example of the colimit operation for a specification.

FIG. 6 shows an example of the colimit operation for a hereditary diagram.

FIG. 7 shows another example of the colimit operation for a hereditary diagram.

FIGS. 8(a), 8(b), and 8(c) show an example user interface for the colimit operation of a hereditary diagram.

FIGS. 9(a)-9(j) show an example of operations initiated by the user to further illustrate the colimit operation for a hereditary diagram.

FIG. 10 is a block diagram of a specification-carrying software code system performing automatic code generation in accordance with the specification-carrying software code.

FIG. 11 shows an example of specification morphism.

FIG. 12 shows an example of composition.

FIG. 13 shows an example of a diagram.

FIG. 14 shows an example of a parameterized diagram.

FIG. 15 shows an example of how specification-carrying software can be used in domain-specific software synthesis.

FIG. 16 shows an example of symbols used to explain EPOXI, an embodiment of a specification-carrying software code system.

FIGS. 17-19 show more EPOXI-related examples.

FIG. 20 shows an example of the impact of specification-carrying software code.

FIG. 21 shows an example of a Boolean gauge for software composability.

FIG. 22 shows an example of a Boolean gauge for software composability of a software wrapper.

### DETAILED DESCRIPTION

General Discussion

In order to support dynamic assembly, software components must carry enough information about their structure and behavior.

Gauge generators:

Many real phenomena yield to measuring only when specially prepared. In order to measure the spreading of a body liquid, physiologists mark it by a radioactive substance. In order to measure the survival rate in a large population, ecologists tag selected parts of it. Similarly, in order to measure the logical distance between software components, we shall prepare a framework in which they come equipped with specific logical markers. This is the idea of specification carrying software (or “self-adaptive code).

With the present invention, it is possible to measure the composability and adaptability of software components in terms of the logical distance of their specifications, viz the degree of consistency of their union. Classically, the consistency of a theory is evaluated in the Boolean algebra 2: a theory is either consistent, or not. In constructivist logic, the consistency can be evaluated in a heyting algebra, e.g. of the open sets of a topological space. In categorical logic, the consistency can be evaluated in a pretopos. A preferred embodiment of the invention uses the simplest space of the truth values sufficient for the practical tasks arising in composing and adapting software.

The precision gauge, measuring how closely is a software component approximated by the specification it carries, is built in into the very foundation of the framework of the described embodiment of the present invention. Each module comes with an explicit satisfaction relation, establishing the sense in which the executable component satisfies the given structural specification. The satisfaction relation of a composite module is derived from the satisfaction relations of the components, and the logical distance of the two specifications.

A composability gauge measures the logical distance, viz the degree of consistency of a union of theories and uses known software theorem.

For example, a composibility gauge may address verifying the functionality/safety, and timing constraints of software.

Propagation and Adaptability Gauges measure the effects of propagating the refinement of one component of an architecture to localize compliance conditions on another component propagating change specifications into the structure of an architecture.

A Gauge Generator is specialized to a given architecture from a model of an architecture.

General Background

In the described embodiment, specification-carrying software inherits from one or more of: proof-carrying code, model-integrated software, or a distributed optimization. In the described embodiment of the present invention, a user specifies his design using a specification language. Specification software manipulates the specified design to yield a more detailed system design. Some of these manipulations involve use of a library of specifications.

The invention is described herein in connection with an embodiment of a system for specifying software. It should be understood that the invention can be used in a number of different software development systems and the description herein is not to be taken in a limiting sense.

Specifications are the primary objects in the described specification language. A specification can represent any system or realm of knowledge such as computer programming or circuit design and describes a concept to some degree of detail. To add properties and extend definitions, the described specification software allows the user to create new specifications that import or combine earlier specifications. This process is called refinement. Composition and refinement are the basic techniques of application development in the described specification software. A user composes simpler specifications into more complex ones, and refines more abstract specifications into more concrete ones. Refining a specification creates a more specific case of it.

In the described embodiment, specifications can represent an object or concept. A complex specification can be presented as a diagram of simpler specifications. A software specification is a formal representation of objects or concepts that come about in a software development project. In the described embodiment, a complex specification can be composed and refined as a diagram of simpler specifications; still more involved specifications can be composed as diagrams of such diagrams; and so on. Large specifications are thus subdivided into diagrams of smaller specifications. The process of software design is stratified into such diagrams, diagrams of diagrams and so on. This is what is meant by the expression “hereditary diagrams of specification.” A diagram includes:

A set of nodes (or vertices)

A set of arcs (or edges or arrows), and

Two mappings, assigning two nodes to each arc: its source-node and its target-node.

The nodes of a diagram of specifications are formal specifications, capturing the relevant objects and concepts to be specified, the arcs of a diagram of specifications are the “specification morphisms,” capturing the relationships between the nodes: how some specifications inherit or share the structure specified in others. Diagrams thus provide a graphically based method for software development and refinement, allowing “modular decomposition” and reuse of software specifications.

The described embodiments of the software development tool support:

Specification refinement: deriving a more concrete specification from a more abstract specification by adding more structural detail

Code generation: when enough structural detail has been specified to determine concrete programming structures suitable to perform the required task, code in a suitable language is generated.

Colimit determination

In general, determination of a colimit is a destructive operation, resulting in the loss of information about the involved diagrams. The described embodiments of the invention protect and retain the diagrams by folding them into a node. Since the described embodiment allow for diagrams of diagrams, this protection can occur in a multi-level diagram of diagrams.

Nodes of a diagram show the objects or concepts and arcs between the nodes show relationships (morphisms) between the nodes. Diagrams are used primarily to create sets of objects and to specify their shared parts, so that the individual parts can be combined. Specifications can also be defined to be hereditary diagrams.

The described specification software allows a user to derive a more concrete specification from a more abstract specification. In general, the complexity of a specification is increased by adding more structural detail. The following techniques are preferably used (separately or together) to refine specifications:

the import operation, which allows a user to include earlier specifications into a later one;

the translate operation, which allows a user to rename the parts of a specification; and

the colimit operation, which glues concepts together into a shared union along shared sub-concepts.

Use of diagrams (and hereditary diagrams) allows the user to retain information about a specification during the design process. The described embodiment of the present invention allows a user to define a specification that is a hereditary diagram and to perform the colimit operation on the hereditary diagram.

The described embodiments include specification diagrams and compute colimits in this category. Furthermore, the described embodiments iterate this procedure, yielding the category of hierarchical diagrams, and computes colimits for these hierarchal diagrams.

The described embodiment provides a software tool for building, manipulating, and reusing a collection of related specifications. The tool allows a user to describe concepts in a formal language with rules of deduction. It includes a database (library) that stores and manipulates collections of concepts, facts, and relationships. The present invention can be used to produce more highly refined specifications until a concrete level of abstraction is reached. For example, a specification can be refined until it reaches the computer source code level. As another example, a specification can be refined until it reaches the circuit level.

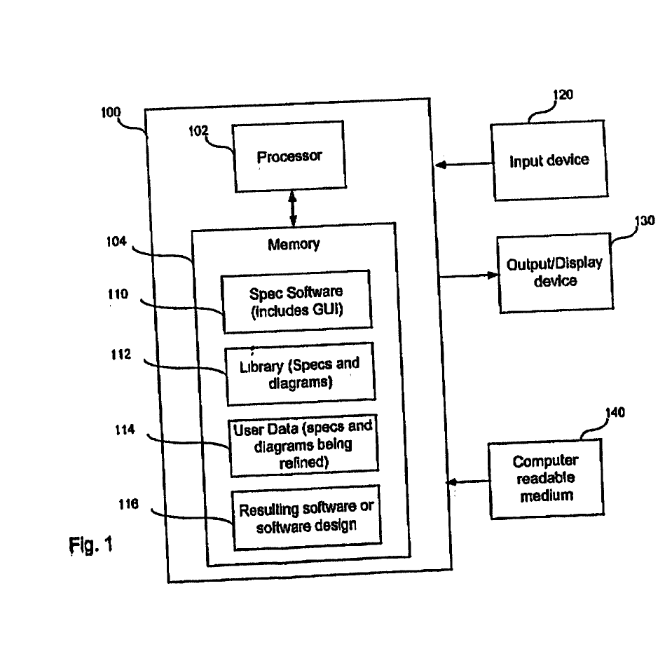

Referring now to FIG. 1, there is shown a block diagram of the overall architecture of an embodiment of the present invention. FIG. 1 includes a data processing system 100 including a processor 102 and a memory 104. Memory 104 includes specification software 110, which implements the refinement methods defined herein. Specification software 110 preferably implements a graphical user interface (GUI) that allows a user to define specifications and morphisms and that allows a user to indicate refinements to be performed on the specifications. Specification software 110 includes or accesses a database 112 that includes definitions of specifications and diagrams. The specification being refined is stored in memory 114. The refinement operations indicated by the user can result in computer code 116 if the user chooses to perform refinements to the computer code level.

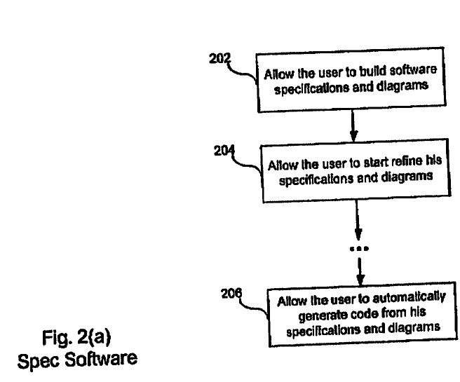

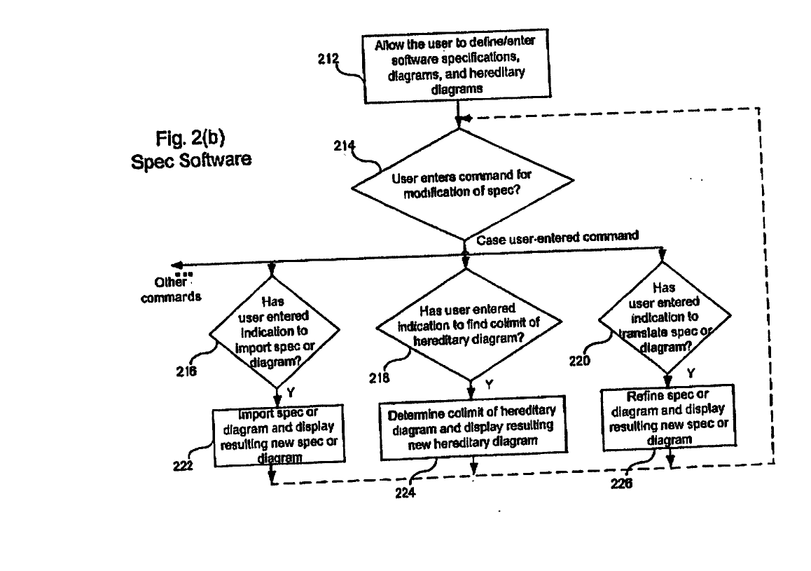

FIGS. 2(a) and 2(b) are flow charts showing step-wise refinements of a specification during an exemplary design process. In element 202 of FIG. 2(a), the user is allowed to define/enter software specifications, diagrams, and hereditary diagrams (also called a “hierarchical diagram” or a “diagrams of diagrams”). Specifications are the primary objects defined by a user. In the described embodiment, specifications can represent a simple object or concept. A specification can also be a diagram, which is a collection of related objects or concepts. As shown in FIG. 29, nodes of a diagram show the objects or concepts and arcs between the nodes show relationships (morphisms) between the nodes. Diagrams are used primarily to create sets of objects and to specify their shared parts, so that the individual parts can be combined. Specifications can also be defined to be hereditary diagrams, where at least one object in a node of the diagram is another diagram.

Specifications can be defined in any appropriate specification language, such as the SLANG language defined by the Kestrel Institute of Palo Alto, Calif. SLANG is defined in the SLANG Users Manual, available from the Kestrel Institute of Palo Alto, Calif. The Slang Users Manual is herein incorporated by reference. A specification can represent any system or realm of knowledge such as computer programming or circuit design and describes a concept to some degree of detail.

In element 204, the user is allowed to start refining his specifications, diagrams, and hereditary diagrams. To add properties and extend definitions, the described specification software allows the user to create new specifications that import or combine earlier specifications. This process is called refinement. Composition and refinement are the basic techniques of application in the described specification software. A user composes simpler specifications into more complex ones, and refines more abstract specifications into more concrete ones. Refining a specification creates a more specific case of it.

The described specification software allows a user to derive a more concrete specification from a more abstract specification. In general, the complexity of a specification is increased by adding more structural detail. The following techniques, among others, are preferably used (separately or together) to refine specifications:

the import operation, which allows a user to include earlier specifications into a later one;

the translate operation, which allows a user to rename the parts of a specification; and

the colimit operation, which glues concepts together into a shared union along shared sub-concepts.

FIG. 2(b) is a flow chart of a method for refining a specification. The user indicates a refinement operation, which is then performed by specification software 110. FIG. 2(b) shows three examples of refinement operations. It will be understood that other refinements are possible. In element 216, the user indicates that a specification or diagram is to be imported. In element 218, the user indicates finding a colimit of a hereditary diagram. In element 220, the user indicates a translation of a specification or diagram.

In element 206 of FIG. 2(a), the user refines his specification to a level of generating computer code. A user may choose not to refine a specification to this level. The refinement process can be used for purposes other than generating computer source code. For example, the refinement process can be used to help understand a specification. As another example, the refinement process can be used to help verify the consistency of a specification.

The Colimit Operation

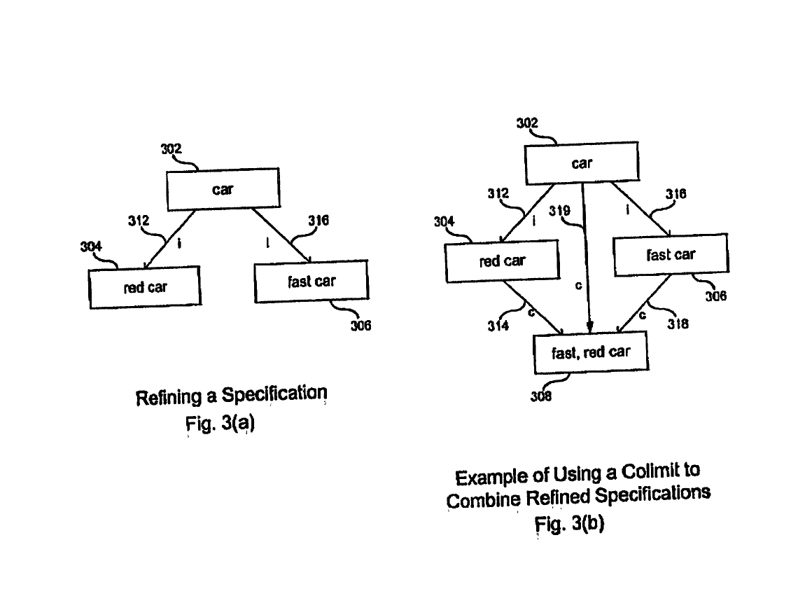

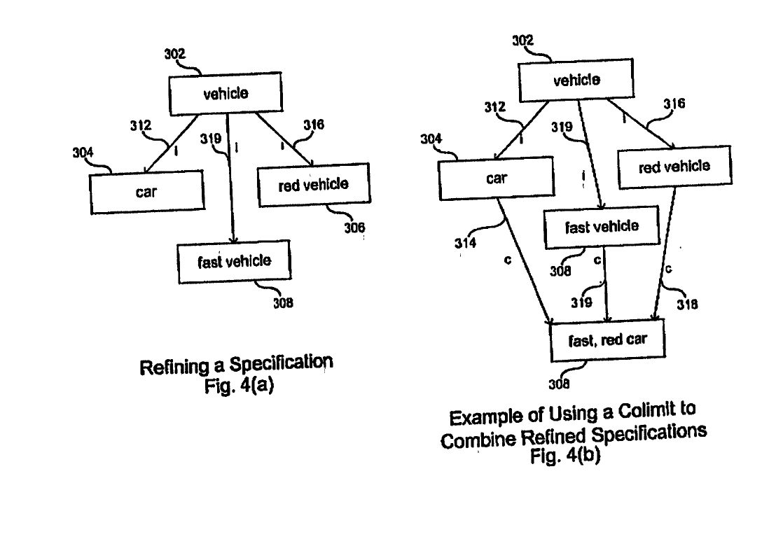

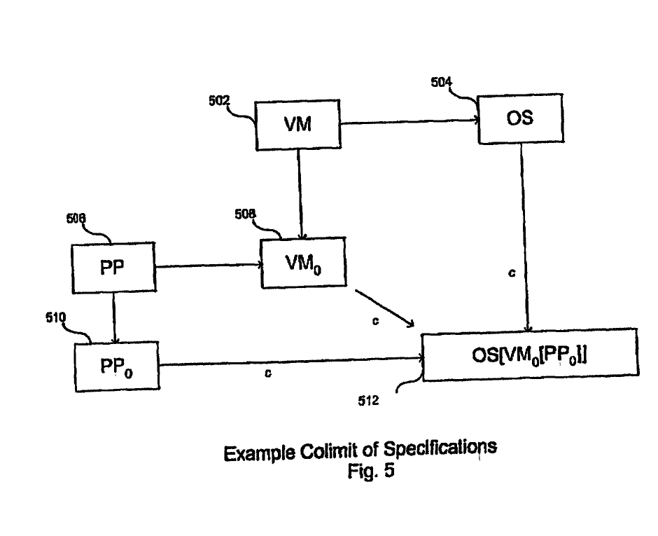

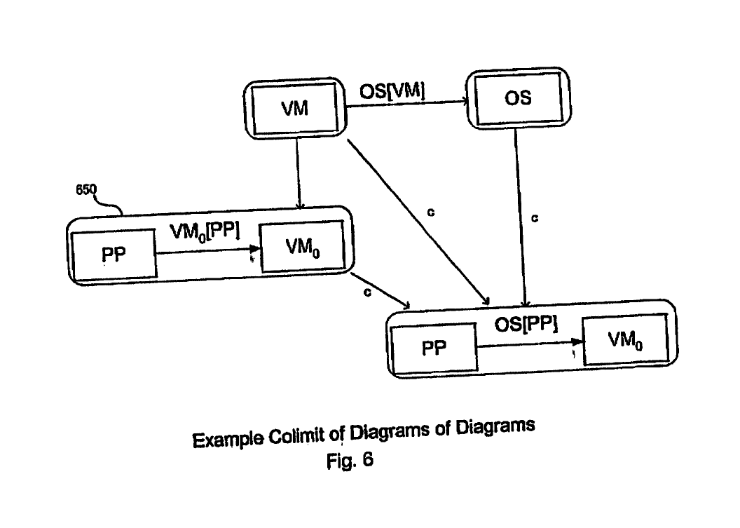

FIGS. 3(a) and 3(b) show a conceptual example of a colimit operation. A colimit is also called “composition” or a “shared union.” A “pushout” is a colimit in which a colimit is taken of a parent node and its two children nodes. It will be understood that the examples of FIGS. 3 and 4 are somewhat simplified and are provided to aid in understanding of the colimit operation. In FIG. 3, the user has defined a specification “car” 302. This specification 302 has been refined by the user as red car 304 and fast car 306. Thus, the arcs from node 302 to 304 and 302 to 306 are labeled with an “i” (for instantiation/import). In FIG. 3(a), the “defining diagram” shows only the spec/morphism diagram from which the colimit is formed. FIG. 3(b) shows a “cocone diagram,” which also shows the colimit and the cocone morphisms (labeled “c”).

In the described embodiment, the GUI labels arcs as follows, although any appropriate labeling and morphisms could be used (or none).

i: instantiation morphism

d: definitional translation

t: transitional morphsim

c: cocone morphism

id: identity morphism

The defining diagram for a colimit is not limited to a three node diagram. A colimit can be taken of any diagram. An example of a different diagram shape is shown in FIG. 3(b). In the colimit operation, any type of node related by morphisms in the diagrams are mapped to the same type of node in the colimit. Conversely, any unrelated types are mapped to different types in the colimit. The same is true of operations.

When you compose specifications, types or operations that have the same names in different component specifications might be mapped to different result operations. For example, suppose specification A and specification B are combined to form specification C. Both A and B have operations named concat, but the operations do not work the same way, and need to be differentiated in specification C. In this case, specification software 110 generates unambiguous names in the colimit. Similarly, types and operations that have different names in the component specifications can be mapped to a single element in the colimit. For example, the operation concat in specification A and add in specification B might both be mapped to a single concatenation operation in the colimit specification C. In this case, the resulting element preferably has both names.

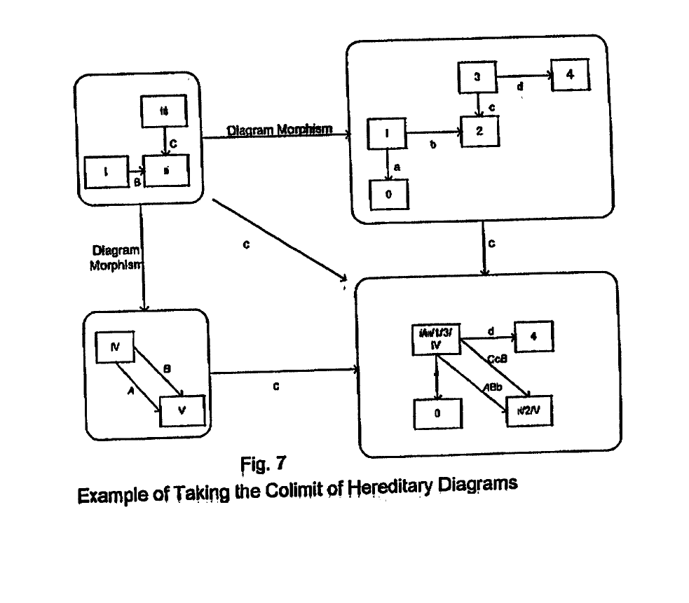

FIG. 5 shows a more realistic example of the colimit operation for a specification. In this example, a virtual memory (VM) is a parameter of the operating system (OS). Suppose we want to formally specify a simple operating system (OS). There are large fragments of the theory that can be abstracted away. In other words, the structure of the system does not depend on a particular virtual memory (VM) implementation. Thus, the formal VM requirements can be taken as a parameter of the formal OS specification. Similarly, a particular VM system, VM_0, can be a parametric in paging policies (PP). Thus, the parameter VM can be instantiated to another parametric specification VM_0.

In this way, a complex system naturally decomposes into simpler components that can be refined independently. When all components are implemented, an implementation of the whole can be automatically generated: an operating system with a particular virtual memory management and with a particular paging policy.

Use of diagrams (specifically, hereditary diagrams) allows the user to retain information about a specification during the design process. Taking the colimit of simple specifications can destroy the structure of the spec. The described embodiment of the present invention allows a user to define a specification that is a hereditary diagram and to perform the colimit operation on the hereditary diagram. This carrying information in a diagram brings the colimit operation into lazy mode. FIG. 6 shows an example of the colimit operation for a hereditary diagram. Various intermediary choices can be made by the user as to how to define a diagram. For example, one may wish to instantiate the virtual memory parameter VM to VM_0, but to keep the page-in policy parameter PP open. The pspecification VM_0 can then be protected as a diagram 650. The colimit operation can then be applied in the category of diagrams, rather than specs. Note that FIG. 6 shows an example of a hereditary diagram in which at least one node is a diagram.

The parameter VM to be instantiated for, lifts to a trivial diagram as well as the specification OS. The colimit of the resulting diagram yields the specification OS parametric over PP as a diagram.

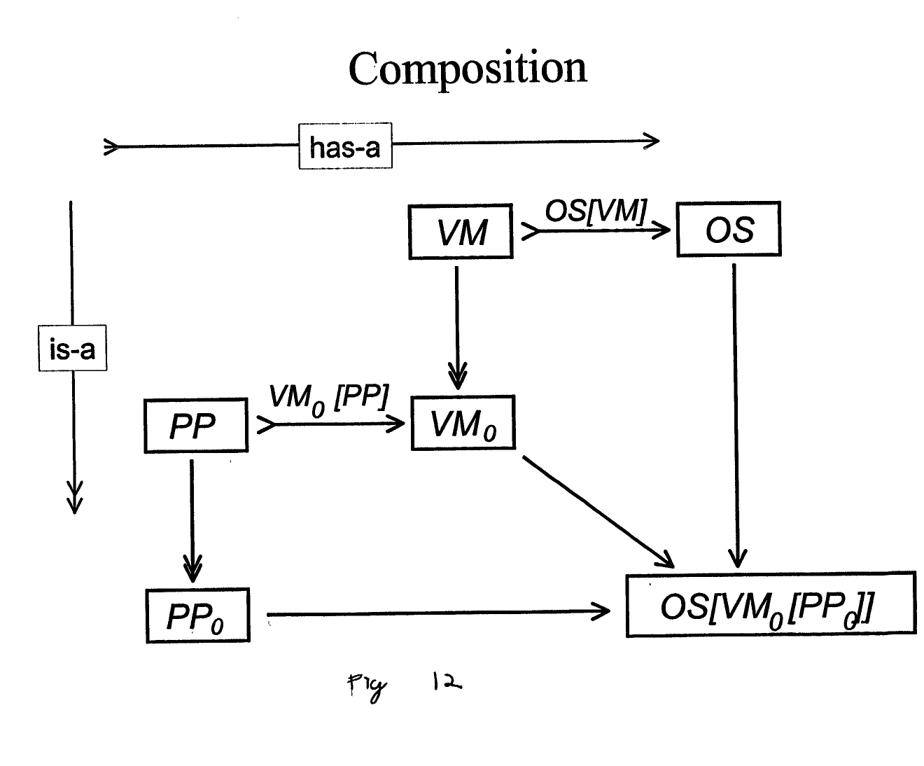

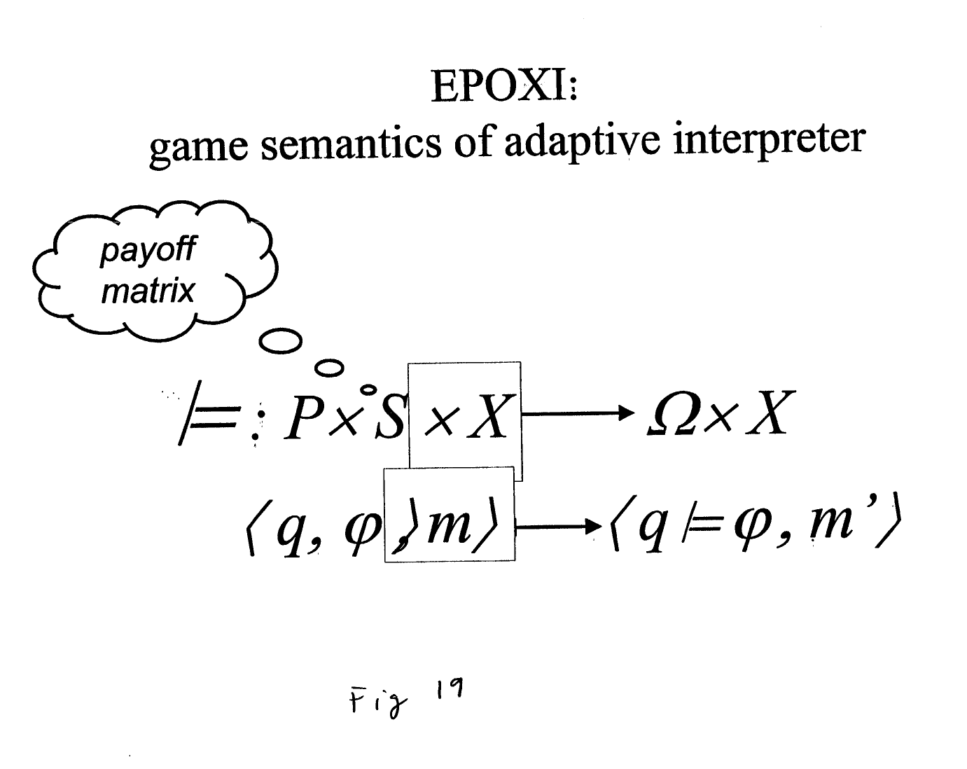

FIG. 7 shows another example of the colimit operation for a hereditary diagram. Implementation details of colimits of hereditary diagrams are discussed below in connection with FIGS. 10-27. Shape changes of even simple diagrams quickly become too complex for human beings to solve intuitively. An automated method is needed, such as that shown in detail herein.

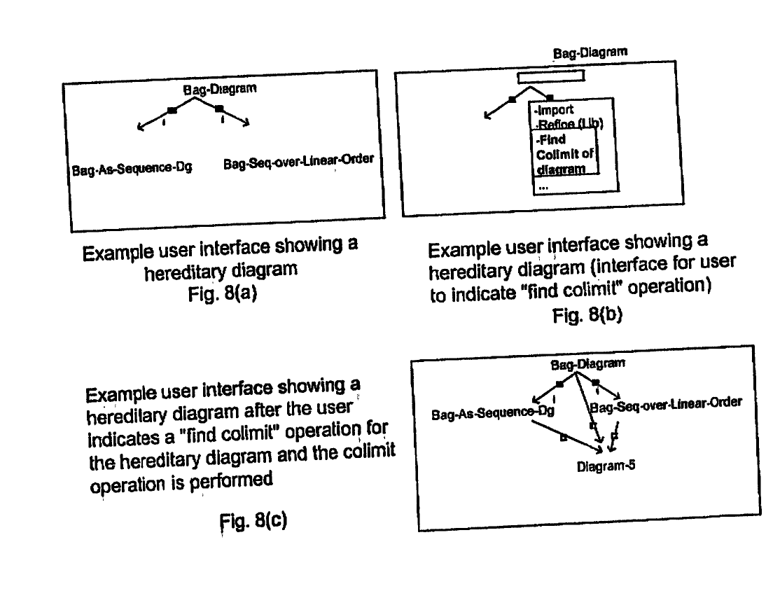

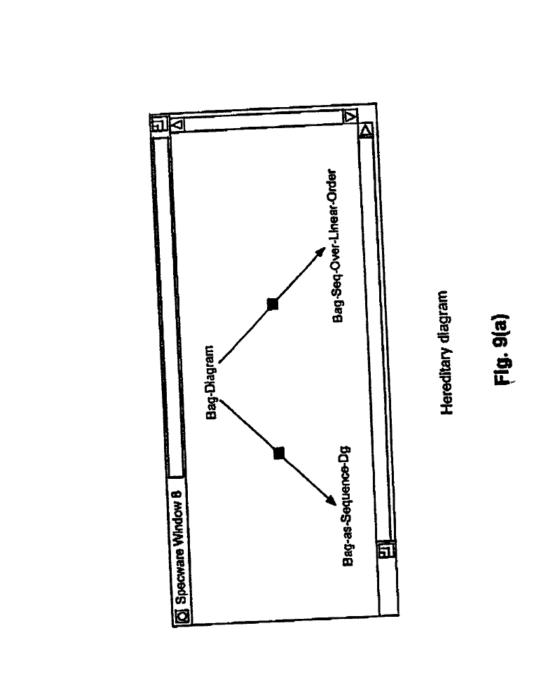

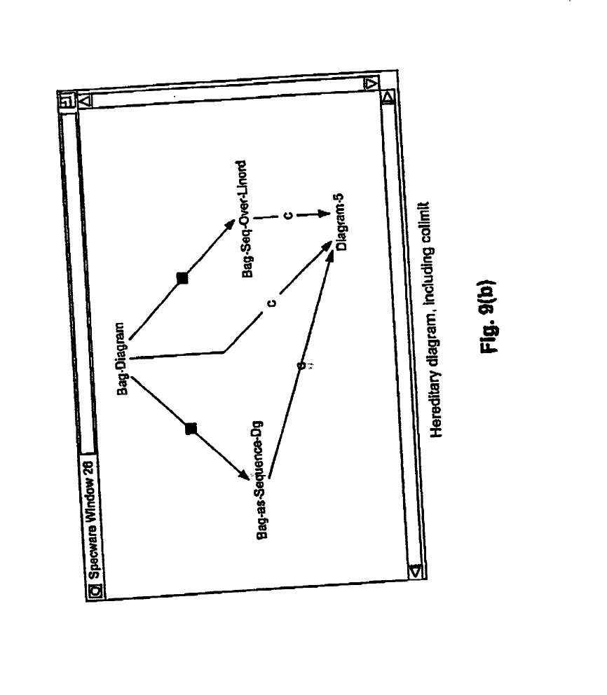

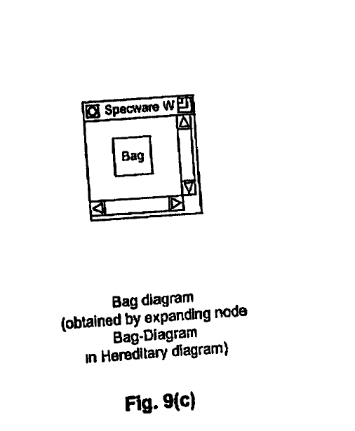

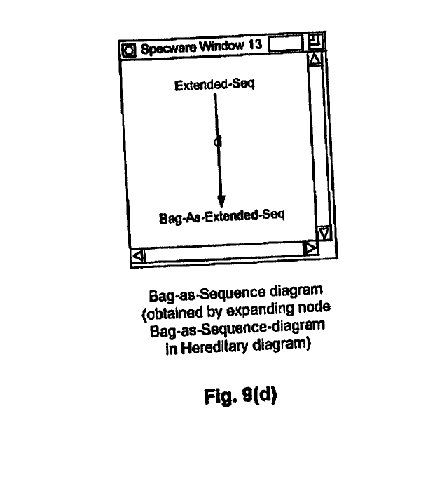

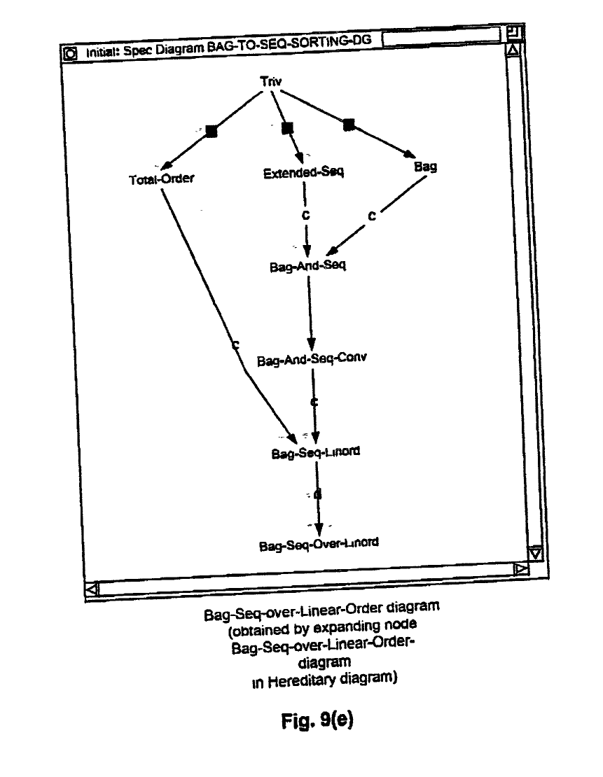

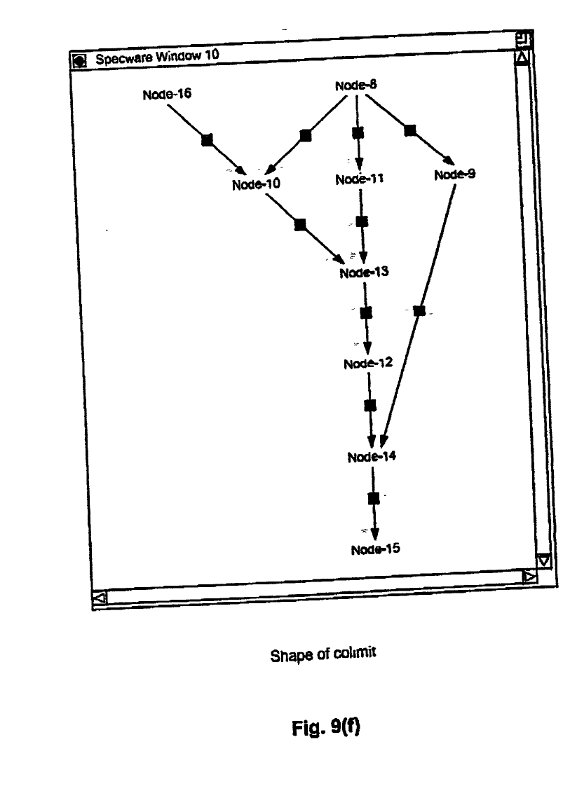

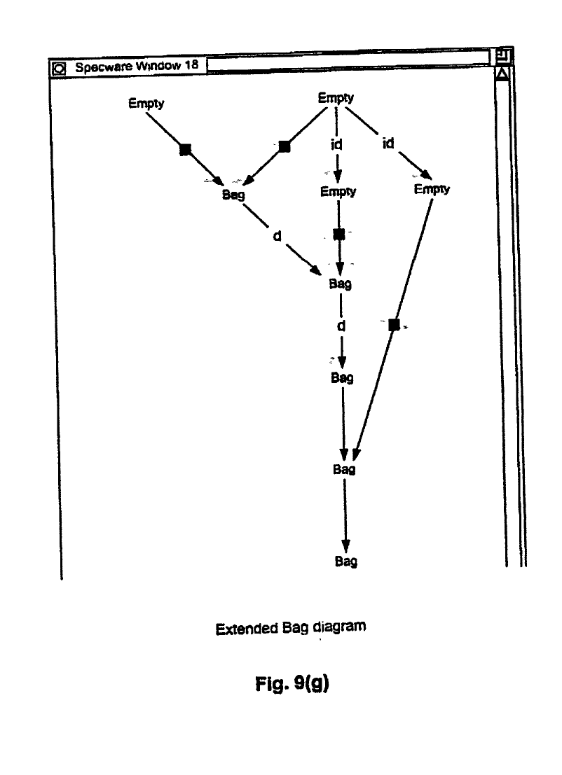

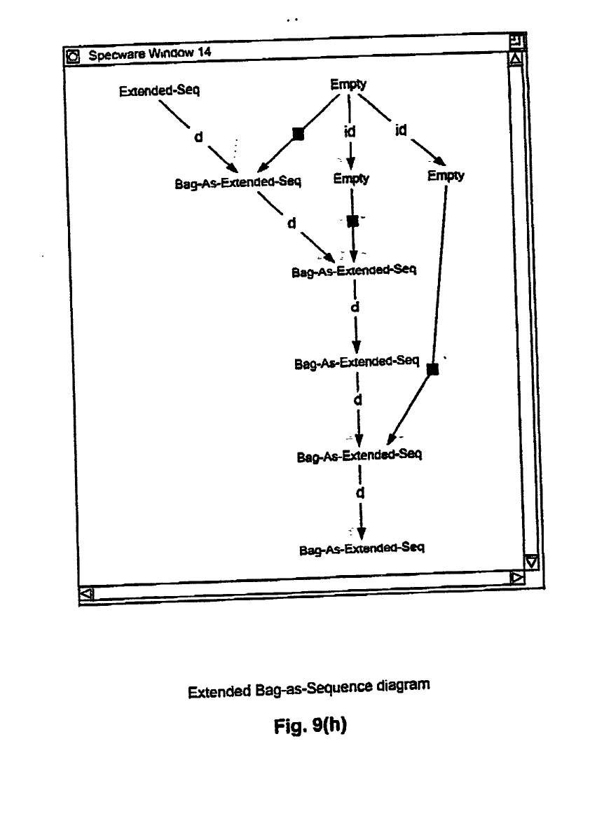

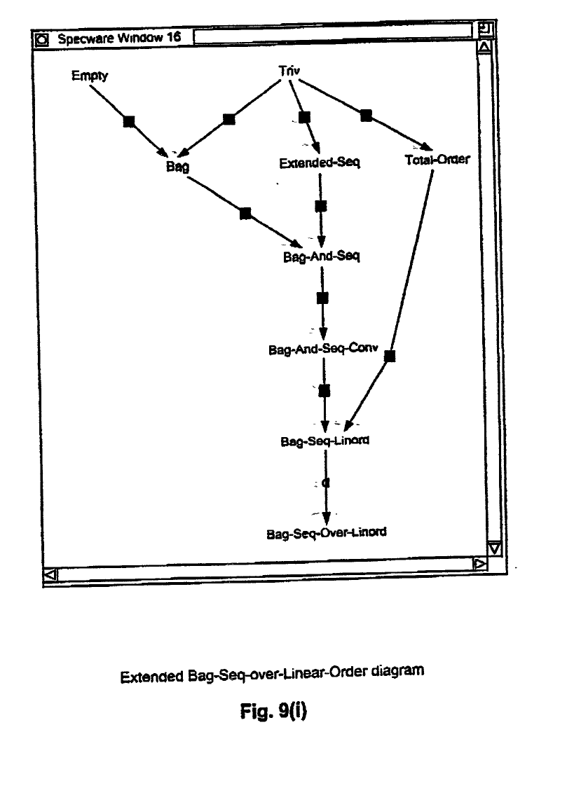

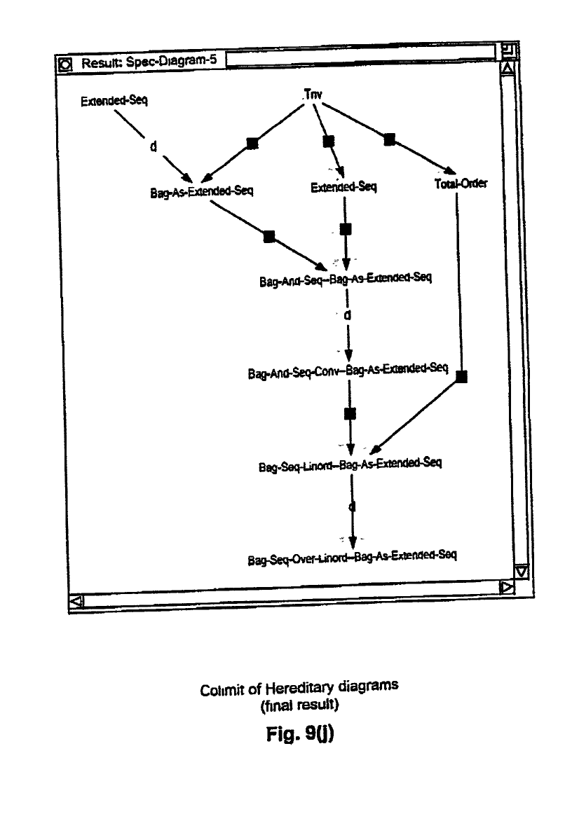

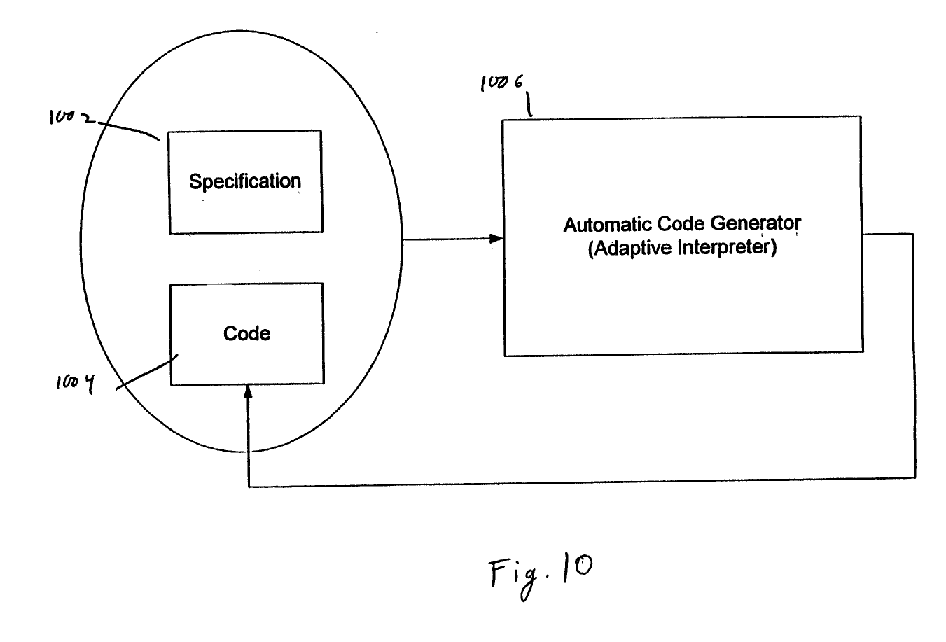

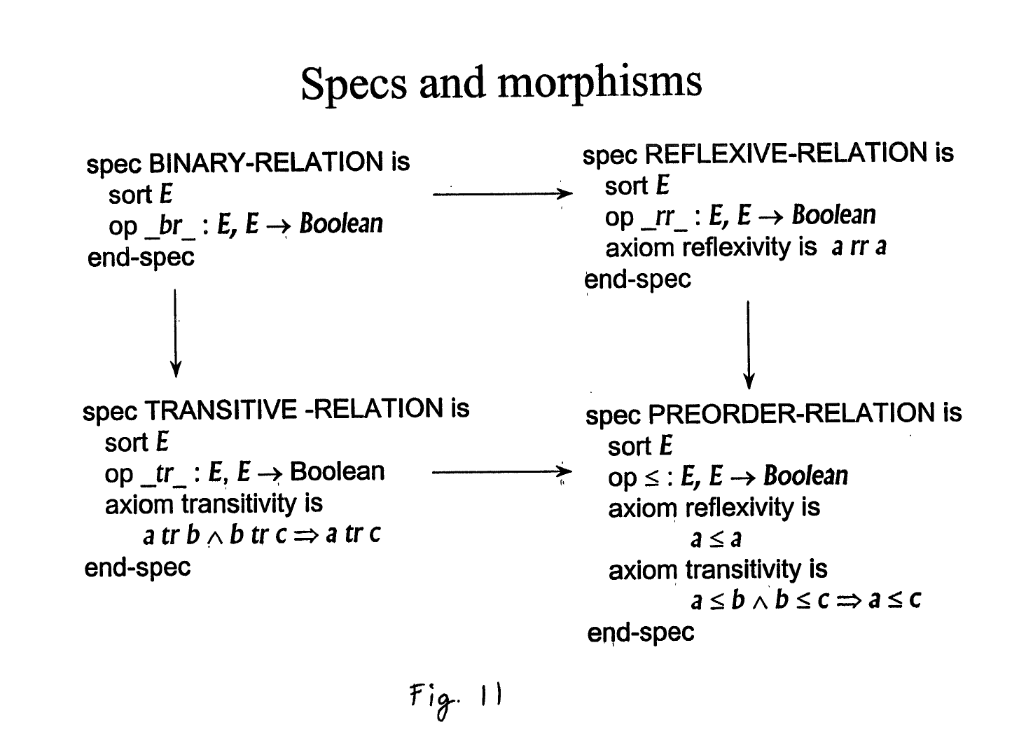

FIGS. 8(a), 8(b), and 8(c) show an example graphical user interface (GUI) for the colimit operation of a hereditary diagram. The display of FIGS. 8 and 9 preferably are generated by specification software 110. In FIG. 8(a), the user has defined a hereditary diagram. An initial (parent) specification is named Bag-Diagram. FIG. 9(c) shows details of Bag-Diagram. (The user may or may not choose to display the detail of the diagram Bag-Diagram and may instead display only the name of the diagram as shown in FIG. 8(a)). In this example, the user has refined the parent specification twice, to yield: Bag-as-Seq-Dg and Bag-Seq-over-Linear-Order. FIGS. 9(d) and 9(e) show details of these diagrams. (The user may or may not choose to display the detail of the diagrams and may instead display only the names of the diagrams as shown in FIG. 8(a)).

In FIG. 8(b), the user has selected the diagram having Bag-Diagram as its parent node and has indicated that he wishes to refine the hereditary diagram specification via the colimit operation. Although the disclosed interface uses a drop-down menu to allow the user to indicate the colimit operation, any appropriate interface can be used. In FIG. 8(c), the colimit is named Diagram-5. FIG. 9(j) shows details of this diagram. (The user may or may not choose to display the detail of the diagram and may instead display only the name of the colimit diagram as shown in FIG. 8(c)).

FIGS. 9(a)-(9j) show an example of operations initiated by the user to further illustrate the colimit operation for a hereditary diagram. FIG. 9(a) shows an initial hereditary diagram. FIG. 9(b) shows an example of the result of the colimit operation indicated by the user. FIG. 9(c) shows an expansion of the Bag-Diagram requested by the user. FIG. 9(d) shows an expansion of the Bag-as-Sequence-Diagram requested by the user. FIG. 9(e) shows an expansion of the Bag-Seq-over-Linear-Order-Diagram requested by the user.

FIGS. 9(f)-9(i) show details of determination of the colimit of the hereditary diagram of FIG. 9(a). FIG. 9(f) shows a shape of the shape colimit, which is the shape that the colimit will eventually have. FIG. 9(g) shows an extension of the Bag-Diagram in accordance with the shape of the colimit. FIG. 9(h) shows an extension of the Bag-as-Sequence-Diagram in accordance with the shape of the colimit. FIG. 9(i) shows an extension of the Bag-Seq-over-Linear-Order-Diagram in accordance with the shape of the colimit. FIG. 9(j) shows an expanded version of Diagram-5, which is the colimit of the hereditary diagram. Note that the colimit has the shape of the diagram of FIG. 9(f).

In a preferred embodiment, the specification associated with a particular piece of software can be viewed in a drop-down window or similar user interface device associated with an appropriate node.

A Description of Specification-Carrying Software Code

FIG. 10 is a block diagram of a specification-carrying software code system performing automatic code generation in accordance with the specification-carrying software code.

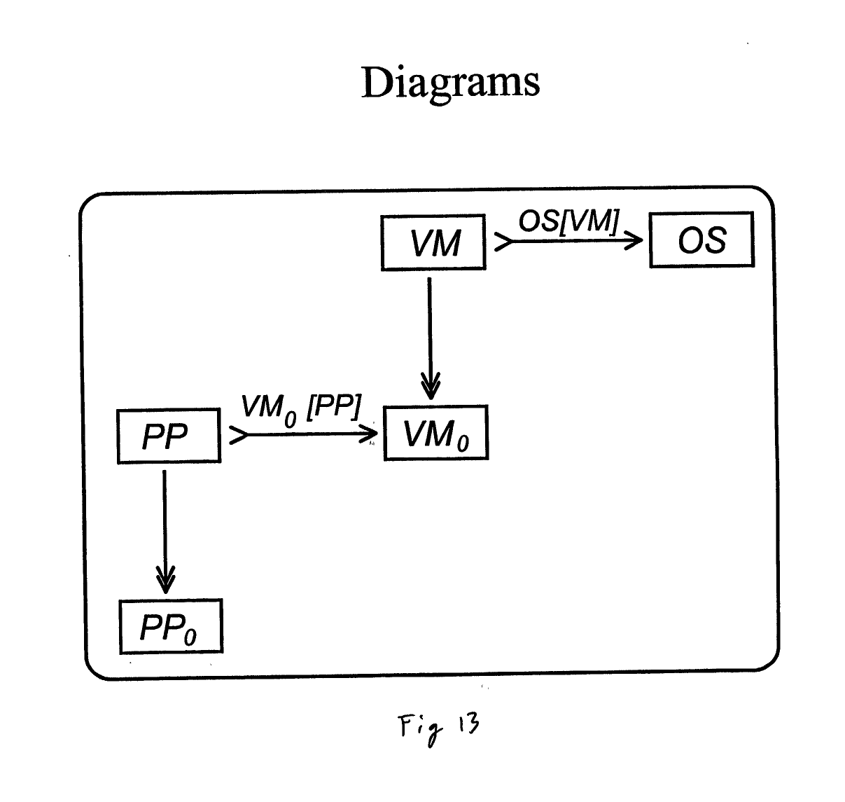

FIG. 11 shows an example of specification morphism. The spec reflexive-relation has an axiomatic reflexivity property, while the spec transitive-relation has an axiomatic transivity property. A spec Preorder-relation must have both these properties and is a colimit as described above.

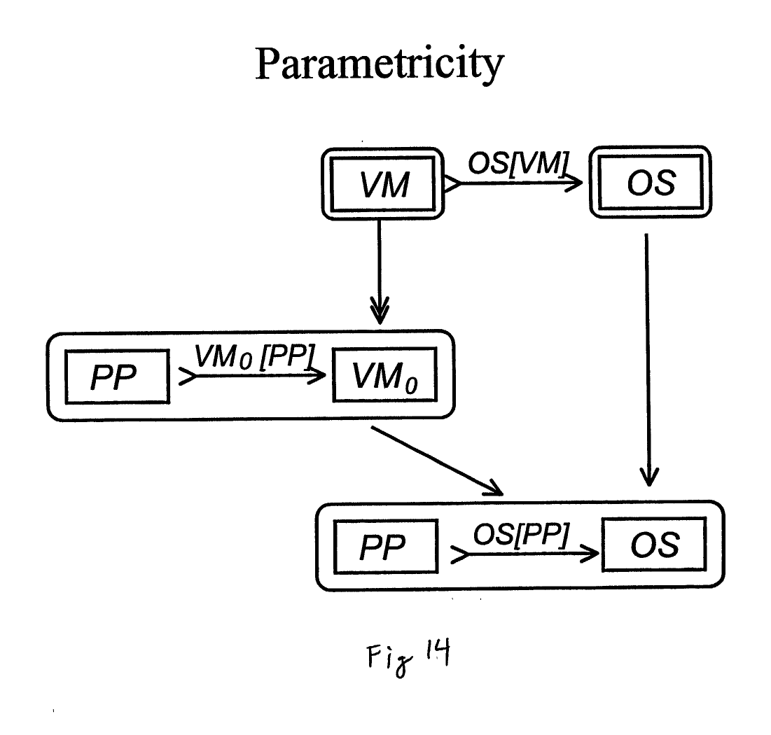

FIG. 12 shows an example of composition. Suppose we want to formally specify a simple operating system (OS). There are large fragments of the theory that can be abstracted away, for example, the structure of the system does not have depend on a particular virtual memory (VM) implementation. Thus, the formal VM requirements can be taken as the parameter of the formal OS specification. Similarly, a particular VM system, VM_0, can be parametric in paging policies (PP). Thus, the parameter VM can be instantiated to another parametric specification VM_0.

In this way, a complex system naturally decomposes into simpler components that can be refined independently. When all components are implemented, an implementation of the whole can be automatically generated: an operating system with a particular virtual memory management and with a particular paging policy.

FIG. 12 also shows an example of an example screen shot showing the interplay of parameters and diagrams.

FIG. 13 shows an example of a diagram. It is important to understand that we want to bring the colimit operation into a “lazy” mode, i.e., to carry around the “aquarium” of information for as long as possible. IN this example, this means that it is desirable to preserve the “module” diagram structure for as long as possible without flattening it out into a colimit.

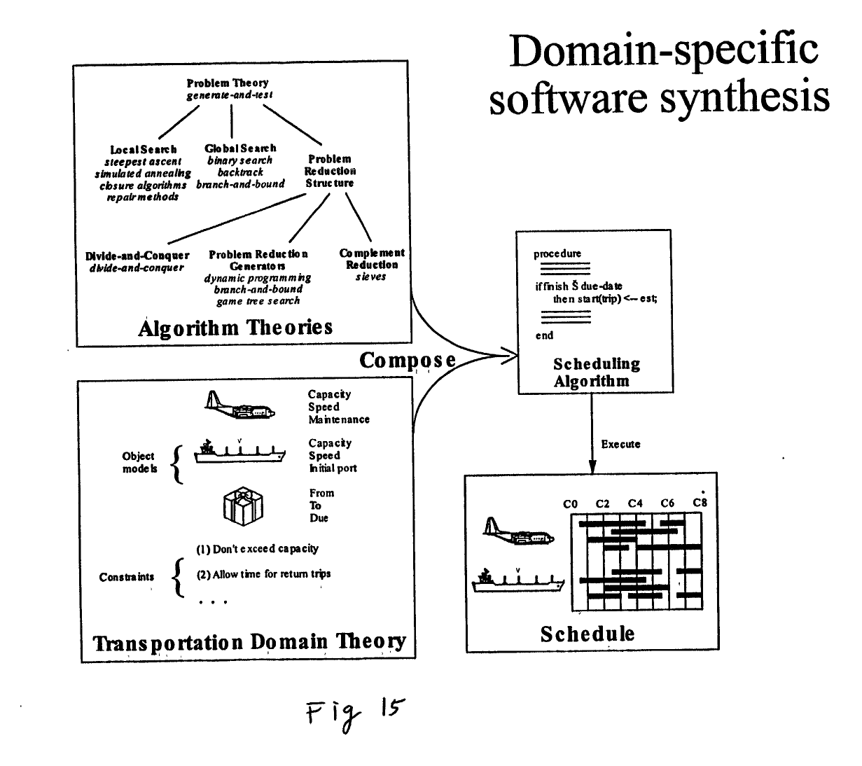

FIG. 14 shows an example of a parameterized diagram. The software tool shown here is highly adaptable. Various intermediary choices are possible, in between the eager option of evaluating colimits at the first opportunity and the lazy option of deferring them. For example, one may wish to instantiate the virtual memory parameter VM to VM_0, but to keep the pagination policy parameter (PP) open. The pspec VM_0 can then be protected as a diagram. The colimit operation can then be applied in the category of “diagrams” rather than “specs.”

The parameter VM, to be instantiated for, lifts to a trivial diagram, as well as the spec OS. The colimit of the resulting diagrams yields the spec OS parametric over PP as a diagram.

In a simple case, such design methods can be supported without any automatic support, since the human user can keep track in his or her head. But, for a scalable design tool, automatic support is not only convenient, but necessary. Fairly small diagrams lead to graph theoretic and logical computations unfeasible for a human user. It is often not immediately obvious how to change the shape of diagrams, and even less which specs to place in association with which node. Moreover, the diagram method lifts from specs to diagrams themselves, to diagrams of diagrams, etc.

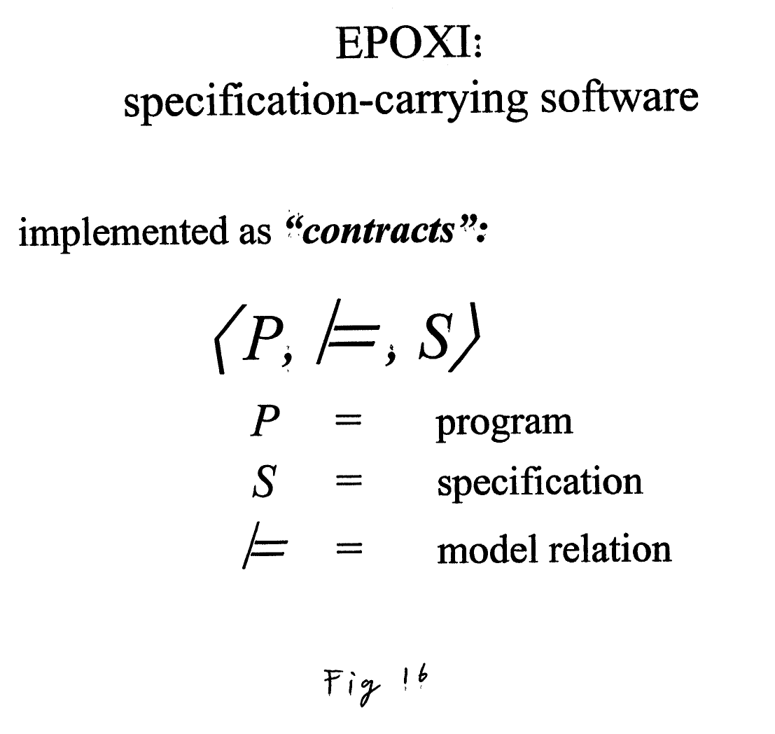

FIG. 15 shows an example of how specification-carrying software can be used in domain-specific software synthesis. This example illustrates how the “algorithm theories” could be composed with the “domain theories” to produce the scheduling algorithm. In this example, various possible algorithms are available, but the transportation domain, for example, has certain constraints that must be met.

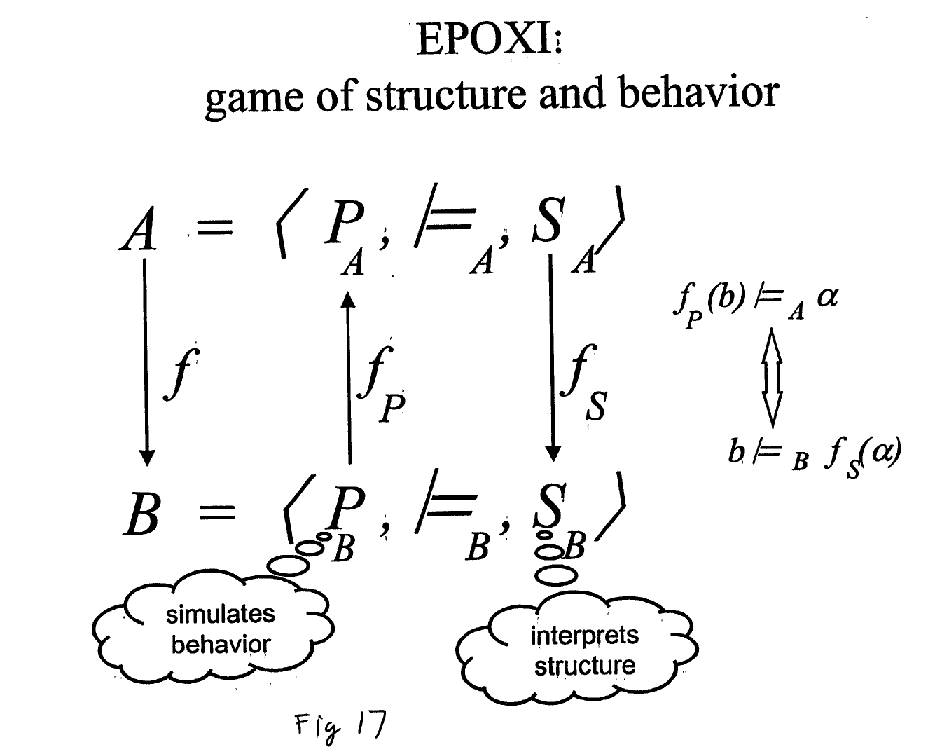

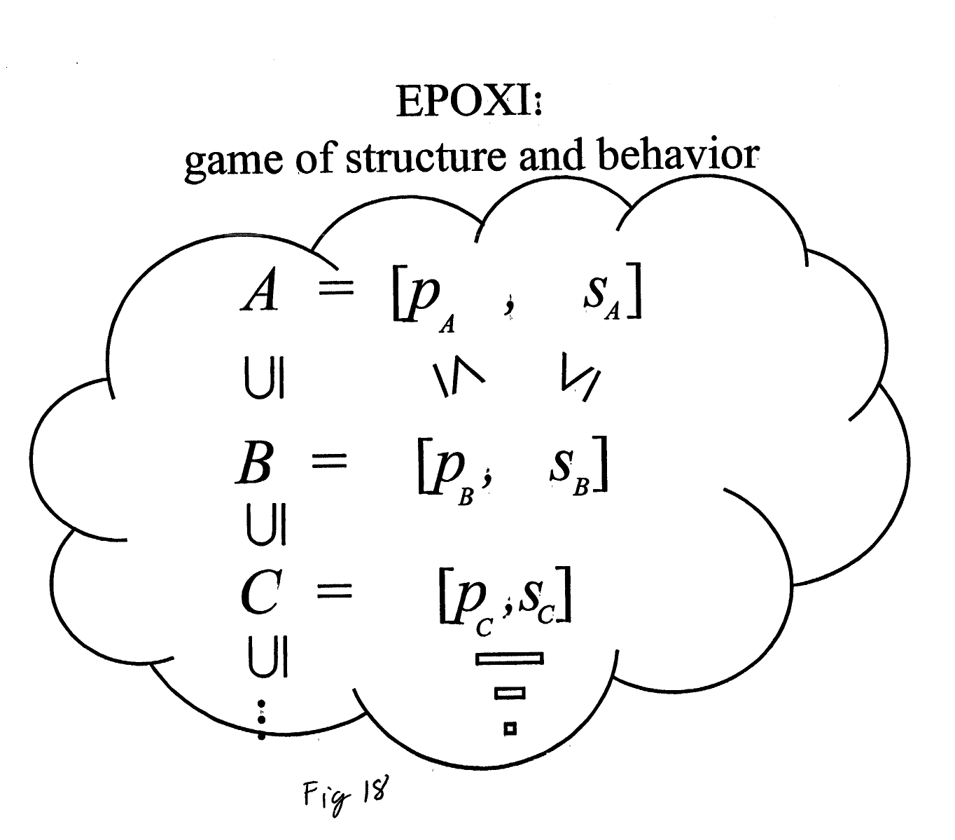

FIG. 16 shows an example of symbols used to explain EPOXI, an embodiment of a specification-carrying software code system. FIGS. 17-19 show more EPOXI-related examples.

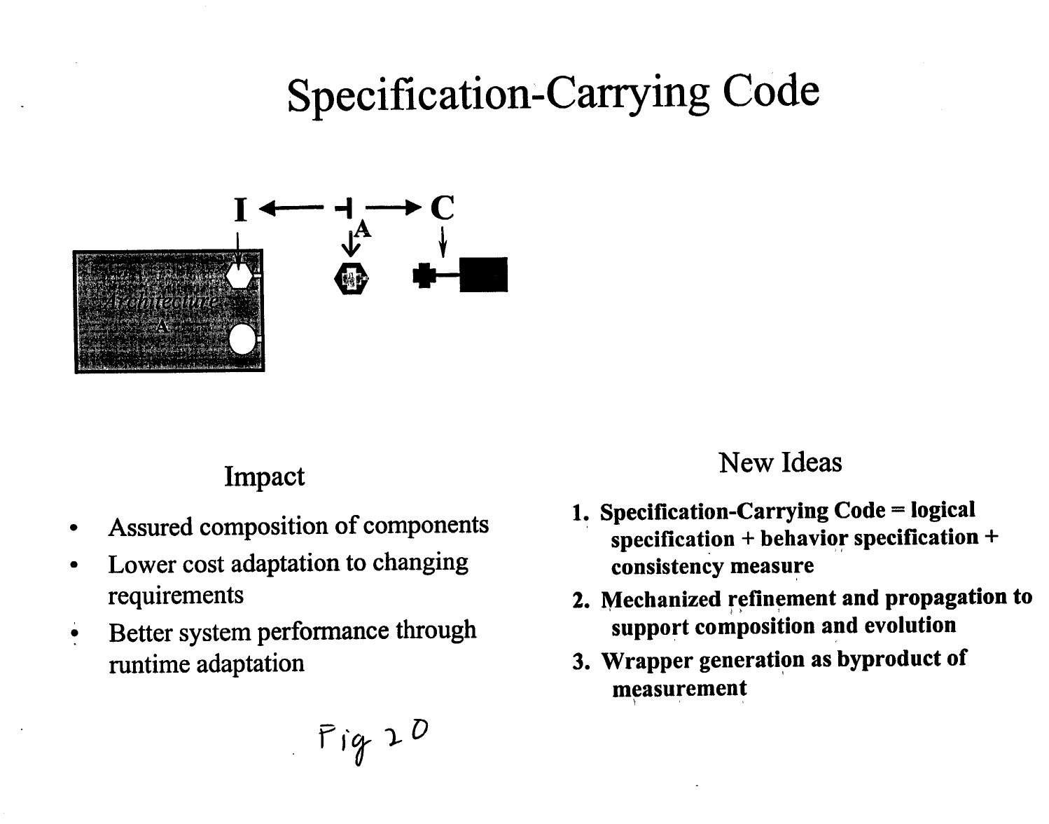

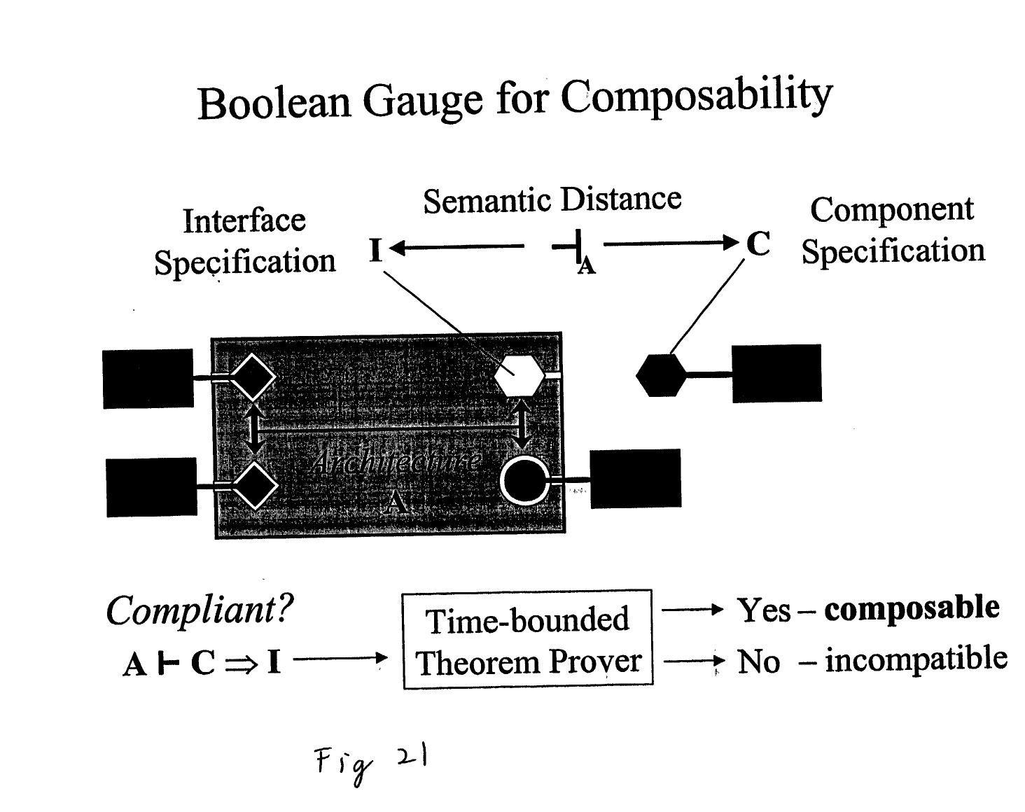

FIG. 20 shows an example of the impact of specification-carrying software code.

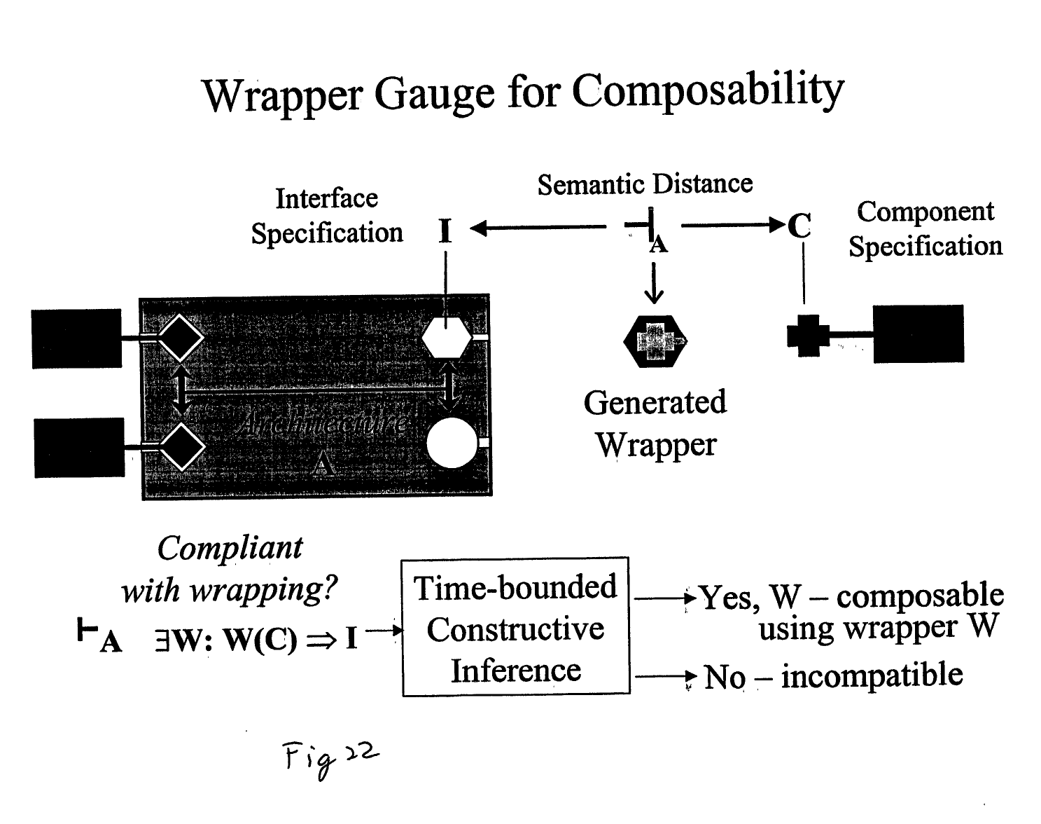

FIG. 21 shows an example of a Boolean gauge for software composability. FIG. 22 shows an example of a Boolean gauge for software composability of a software wrapper.

The following paragraphs, which form a part of this specification, contain further discussions of specification carrying code and of the EPOXI system, which is, of course, an example embodiment of the present invention and is not to be taken in a limiting sense.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of developing a self-modifying computer program, comprising:
providing a set of partial software code implementations;
providing a set of specifications describing functionality of a software program, certain specifications in the set of specifications being paired with certain partial software program code implementations in the set of partial software program code implementations;
generating a software program that includes the set of partial software program code implementations and having functionality described by the set of specifications;
redefining the functionality of the software program when the generated software program does not comport to a minimum functionality standard; and
regenerating the software program so that it still includes the set of partial software program code implementations but has the redefined functionality.

2. The method of claim 1, where the redefined functionality is mandated by a change in an external interface of the software program.

3. The method of claim 1, where the redefined functionality is mandated by a change in an interface within the software program.

4. A method of developing a self-modifying computer program, comprising:
providing a set of partial software program code implementations;
providing a set of specifications describing functionality of a software program, certain specifications in the set of specifications being paired with certain partial software program code implementations in the set of partial software program code implementations;
generating a software program that includes the set of partial software program code implementations and having functionality described by the set of specifications;
redefining the set of partial software program code implementations; and
regenerating the software program so that it includes the redefined set of partial software program code implementations but still has the functionality described by the set of specifications.

5. The method of claim 4, where the redefined partial software program code implementations make the regenerated software program more efficient.

6. The method of claim 4, where the redefined partial software program code implementations make the regenerated software program faster executing.

7. The method of claim 4, where the redefined partial software program code implementations are mandated by a version change.

8. The method of claim 4, where the redefined partial software program code implementations are mandated by a change in an interface of the software program.

9. The method of claim 4, where the redefined partial software program code implementations are mandated by a change in an interface within the software program.

10. A method of developing a self-modifying computer program, comprising:
providing a set of partial software program code implementations;
providing a set of functional comments describing functionality of a software program, certain functional comments in the set of functional comments being paired with certain partial software program code implementations in the set of partial software program code implementations;
generating a software program that includes the set of partial software program code implementations and having functionality described by the functional comments;
redefining the set of functional comments; and
regenerating the software program so that it still includes the set of partial software program code implementations but has redefined functionality in accordance with the set of functional comments.
